(19) United States
(12) Patent Application Publication
(10) Pub. No.: US 2011/0248108 A1
(43) Pub. Date: Oct. 13, 2011

(54) BLENDER AND FOOD PROCESSOR DEVICE

(76) Inventor: Mark C. Carriere, Granada Hills, CA (US)

(21) Appl. No.: 12/901,424

(22) Filed: Oct. 8, 2010

Related U.S. Application Data
(60) Provisional application No. 61/250,458, filed on Oct. 9, 2009.

(51) Int. Cl. B02C 23/04; B02C 25/00

(52) U.S. Cl. 241/33; 241/37.5

(57) ABSTRACT

A food blender and processor device comprising a motor at the base and a rotating shaft with a plurality of rotatable blade modules, which also includes a safety system that activates to enables activation of the device if the cap is tightly secured onto the top opening of the food blender and process device.

### CROSS-REFERENCE TO RELATED APPLICATIONS

This Application claims the benefit of priority of the co-pending U.S. Utility Provisional Patent Application No. 61/250,458, filed Oct. 9, 2009, the entire disclosure of which is expressly incorporated by reference herein.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND OF THE INVENTION

1. Field of the Invention

This invention generally relates to blender and food processing devices and, more particularly, to blender and food processing devices with a rotating shaft having a plurality of rotatable blade modules, including safety mechanisms.

2. Description of Related Art

Conventional blenders or food processing devices with rotating shafts that include a plurality of rotatable blade modules are known and have been used for a number of years. Conventional blenders and food processing devices that include plurality of rotatable blades along most of the length of the rotating shaft general position the electric rotating motor of the device on the enclosing top as part of the enclosed cap that mounts onto a vessel or pitcher of the device for added safety. This ensures that the blender and the rotating shaft will function only if the motor-cap combination is secured onto the top of the vessel or pitcher.

Regrettably, the move of the rotating motor with its fairly heavy mechanical and electrical drive components (including vibrations thereof during operation) to the top of the vessel or pitcher shifts the overall weight of the conventional blender or food-processing device to a higher elevation, which elevates its center of mass, thereby reducing the overall stability of the device. This reduction in overall stability may and can cause the entire device to easily tilt. To avoid tilting during operation, some conventional devices have provided a safety and actuation switch on the motor-cap that compels users to constantly hold and apply a grip pressure or force on the motor-cap safety switch (and hence the pitcher). However, this constant, vigilant holding or griping of the blender creates an added inconvenience for most users, especially for those that use such blenders in business settings where the users must process customer orders while taking care of other business matters, including other customers.

To prevent titling, other conventional devices exist that have a lower section that includes additional mass in the form of a thickened glass, metal ring or iron balls or rod molded into the bottom of the vessel or pitcher for added stability (with the added mass countering the weight of the motor at the top of the vessel or pitcher). Still others enlarge the bottom of the vessel or the pitcher to increase its footprint for further stability. However, addition of mass to the vessel increases the overall weight of the vessel and increasing its so-called footprint increases its bulk, making the overall use of the vessel in terms of handling the vessel very inconvenient and difficult due to added weight and bulk, especially when the vessel is full of blended or processed material (e.g., juice).

A further drawback with most conventional blenders with a top mount motor is that the move of the rotating motor to the top of the vessel or pitcher requires the use of additional components to enable the top enclosure to accommodate the motor itself and finally, the size (in terms of actual motor dimensions, power output, etc.) of the top-mount motor is generally reduced for added safety, which reduces the number, amount, and types of food that may be blended or processed.

Accordingly, in light of the current state of the art and the drawbacks to blenders and food processing devices that use plurality of blades on a rotating shaft mentioned above, a need exists for a blender and food processing device that would address the safety concerns of ensuring the closure of access to the plurality of blades within a vessel or pitcher during operation of the device, but without the use or the need of a motor as part of the cap or cover for the vessel or pitcher to ensure proper safe operations.

### BRIEF SUMMARY OF THE INVENTION

An exemplary aspect of the present invention provides a blender and processor device, comprising:

a base that houses a motor;

a vessel with a handle that includes a top opening and a bottom coupler, with the bottom coupler of the vessel detachably mounted on top of the base;

a cap that detachably couples with the top opening of the vessel;

the motor accommodated within the base includes a rotating drive that is extended out of the base;

a rotating shaft with a plurality of rotatable blade modules includes a bottom distal end having a rotating coupler that couples the rotating shaft with the bottom coupler of the vessel and the rotating drive of the motor;

the rotating shaft further includes a top distal end that is inserted within a stabilizing cavity positioned underneath the cap; and

a safety system that activates to enables activation of the device;

the safety system activates if the top distal end of the rotating shaft is inserted within the stabilizing cavity underneath the cap, and the cap is tightly secured onto the top opening of the vessel.

Another exemplary optional aspect of the present invention a blender and processor device, wherein:

the rotating shaft is threaded, enabling the plurality of rotatable blade modules to be adjustably mounted on the rotating shaft.

Yet another exemplary optional aspect of the present invention a blender and processor device, wherein:

the rotating shaft is one of a straight and non-linear configurations.

Still another exemplary optional aspect of the present invention a blender and processor device, wherein:

a rotatable module of the plurality of rotatable blade modules is comprised of at least two blades.

A further exemplary optional aspect of the present invention a blender and processor device, wherein:

the safety system includes:

a safety switching system that is comprised of:

a power source;

a sensor-switch that activates upon detection of a presence of the top distal end of the rotating shaft within the stabilizing cavity underneath the cap;

a manual safety switch coupled in series with the sensor-switch that is activated by a user;

a wireless transmitter that transmits a signal when the sensor-switch and the manual safety switch are activated;

a receiver-switch that receives the signal from the wireless transmitter;

an operating switching that is activated by the user and that activates the device only when the receiver-switch is closed.

Still a further exemplary optional aspect of the present invention a blender and processor device, wherein:

the power source, the sensor-switch, the manual safety switch, and the wireless transmitter are housed within the cap; and

the receiver-switch and the operating switch are housed within the base.

Yet a further exemplary optional aspect of the present invention a blender and processor device, wherein:

the power source is a battery.

Another exemplary optional aspect of the present invention a blender and processor device, wherein:

the sensor-switch is a proximity switch that is activated when an activation mechanism of the top distal end of the rotating shaft is near the proximity switch.

Yet another exemplary optional aspect of the present invention a blender and processor device, wherein:

the proximity switch is a magnetic proximity switch and the activation mechanism of the top distal end of the rotating shaft is a magnet; and

the magnetic proximity switch closes when the magnet of the top distal end of the rotating shaft is inserted within the stabilizing cavity of the cap, near the magnetic proximity switch.

Still another exemplary optional aspect of the present invention a blender and processor device, wherein:

the magnetic proximity switch is a reed switch.

A further exemplary optional aspect of the present invention a blender and processor device, wherein:

the sensor-switch is comprised of:

an infrared sensor; and

an infrared proximity switch.

Yet a further exemplary optional aspect of the present invention a blender and processor device, wherein:

the receiver-switch is comprised of:

a wireless receiver that receives the wireless transmission signal from the wireless transmitter; and

an auxiliary switch that activates to enable the activation of the device by the operating switch.

Still a further exemplary optional aspect of the present invention a blender and processor device, wherein:

the manual safety switch remains closed when actuated, but deactivate and opens automatically.

Another exemplary optional aspect of the present invention a blender and processor device, wherein:

the operating switch is the ON and OFF switch of the device.

Yet another exemplary optional aspect of the present invention a blender and processor device, wherein:

the safety system includes:

an safety actuation flange as an integral part of the cap;

an interlock shaft that is moved by the interlock flange when the cap is detachably coupled with the top opening of the vessel, the movement of which, in turn, actuates an interlock micro-switch within the base, enabling activation of the safety system.

Still another exemplary optional aspect of the present invention a blender and processor device, wherein:

the vessel includes a shaft housing that accommodates the interlock shaft, with a first interlock shaft distal end substantially flush with a first shaft housing distal end, and a second interlock shaft distal end that extends beyond a second shaft housing distal end to contact the interlock micro-switch upon closure of the cap.

A further exemplary optional aspect of the present invention a blender and processor device, wherein:

the first shaft housing distal end of the vessel accommodates the safety actuation flange upon closure of the cap.

Still a further exemplary optional aspect of the present invention a blender and processor device, wherein:

the interlock shaft is longitudinally moved along a reciprocating path within the shaft housing by the safety actuation flange.

Another exemplary optional aspect of the present invention a blender and processor device, wherein:

the interlock shaft includes an actuator seal at the second interlock shaft distal end that contacts an interlock micro-switch actuator lever to actuate the interlock micro-switch.

Yet another exemplary optional aspect of the present invention a blender and processor device, wherein:

the stabilizing cavity is comprised of a stationary bushing support that encloses a stationary bushing within which is inserted the top distal end of the rotating shaft.

Another exemplary aspect of the present invention a blender and processor device, comprising:

a base that houses a motor;

a vessel with a handle that includes a top opening and a bottom coupler, with the bottom coupler of the pitcher detachably mounted on top of the base;

a cap that detachably couples with the top opening of the vessel;

the motor accommodated within the base includes a rotating drive that is extended out of the base;

a rotating shaft with a plurality of rotatable blade modules includes a bottom distal end having a rotating coupler that couples the rotating shaft with the bottom coupler of the vessel and the rotating drive of the motor;

the rotating shaft further includes a top distal end that is inserted within a stabilizing cavity positioned underneath the cap; and

a safety system that activates to enables activation of the device;

the safety system activates if the top distal end of the rotating shaft is inserted within the stabilizing cavity underneath the cap, and the cap is tightly secured onto the top opening of the vessel;
the safety system includes:
a safety switching system that is comprised of:
a power source;
a sensor-switch that activates upon detection of a presence of the top distal end of the rotating shaft within the stabilizing cavity underneath the cap;
a manual safety switch coupled in series with the sensor-switch that is activated by a user;
a wireless transmitter that transmits a signal when the sensor-switch and the manual safety switch are activated;
a receiver-switch that receives the signal from the wireless transmitter;
an operating switching that is activated by the user and that activates the device only when the receiver-switch is closed.

Another exemplary aspect of the present invention a blender and processor device, comprising:

a base that houses a motor;

a vessel with a handle that includes a top opening and a bottom coupler, with the bottom coupler of the vessel detachably mounted on top of the base;

a cap that detachably couples with the top opening of the vessel;

the motor accommodated within the base includes a rotating drive that is extended out of the base;

a rotating shaft with a plurality of rotatable blade modules includes a bottom distal end having a rotating coupler that couples the rotating shaft with the bottom coupler of the vessel and the rotating drive of the motor;

the rotating shaft further includes a top distal end that is inserted within a stabilizing cavity positioned underneath the cap; and

a safety system that activates to enables activation of the device;
the safety system activates if the top distal end of the rotating shaft is inserted within the stabilizing cavity underneath the cap, and the cap is tightly secured onto the top opening of the vessel;
the safety system includes:
an interlock flange as an integral part of the cap;
an interlock shaft that is moved by the interlock flange when the cap is detachably coupled with the top opening of the vessel, the movement of which, in turn, actuates an interlock micro-switch within the base, enabling activation of the safety system.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1 is an exemplary illustration of a blender and processor device in accordance with the present invention;

FIGS. 2A to 2D are exemplary illustrations of various vessels of a blender and processor device in accordance with the present invention;

FIG. 2E is an exemplary illustration of a cooperative relationship between blender and processor tool and a stabilizing cavity of a cap of a blender and processor device in accordance with the present invention;

FIGS. 3A to 3C are exemplary illustrations of a cap of the blender and processor illustrated in FIG. 1, including exemplary schematic illustration of a safety system in accordance with the present invention;

FIG. 4A is an exemplary illustration of another blender and food processor in accordance with the present invention;

FIG. 4B is an exemplary illustration of the blender and food processor exemplarily illustrated in FIG. 4A, but with a cap detached in accordance with the present invention;

FIGS. 4C and 4D are exemplary illustration of the various views of a cap of the blender and food processor exemplarily illustrated in FIG. 4A in accordance with the present invention;

FIG. 4E is an exemplary sectional view of the cap of the blender and food processor exemplarily illustrated in FIG. 4A in accordance with the present invention;

FIG. 4F is an exemplary enlarged view of a section of the blender and food processor exemplarily illustrated in FIG. 4A in accordance with the present invention;

FIGS. 5A to 5D are exemplary sectional views of the blender and food processor of FIG. 4A in accordance with the present invention;

FIG. 6 is an exemplary schematic illustration of a safety system of the blender and processor device of FIG. 4A in accordance with the present invention; and

FIG. 7 is an exemplary illustration of yet another blender and food processor in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

The present invention provides a blender and food processing device that addresses the safety concerns of ensuring the closure of access to the plurality of blades within a vessel or pitcher during operation of the device, but without the use or the need of a motor as part of the cap or cover for the vessel or pitcher to ensure proper safe operations.

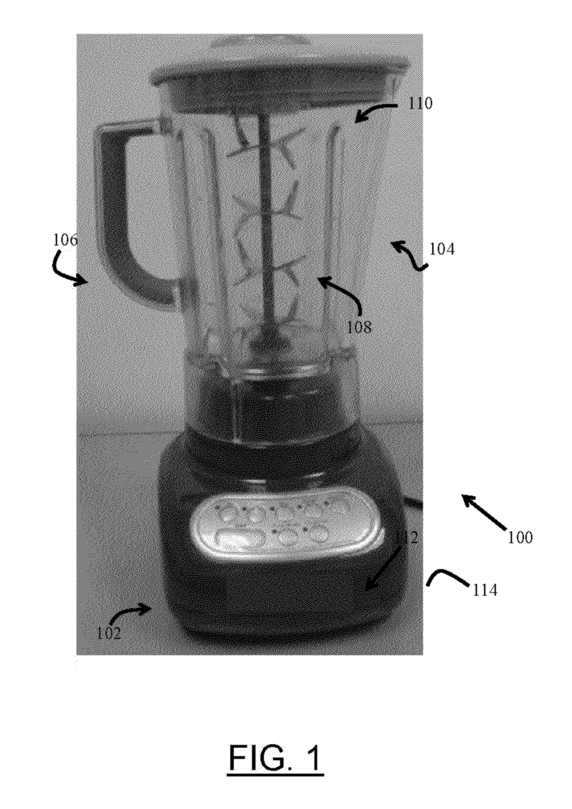

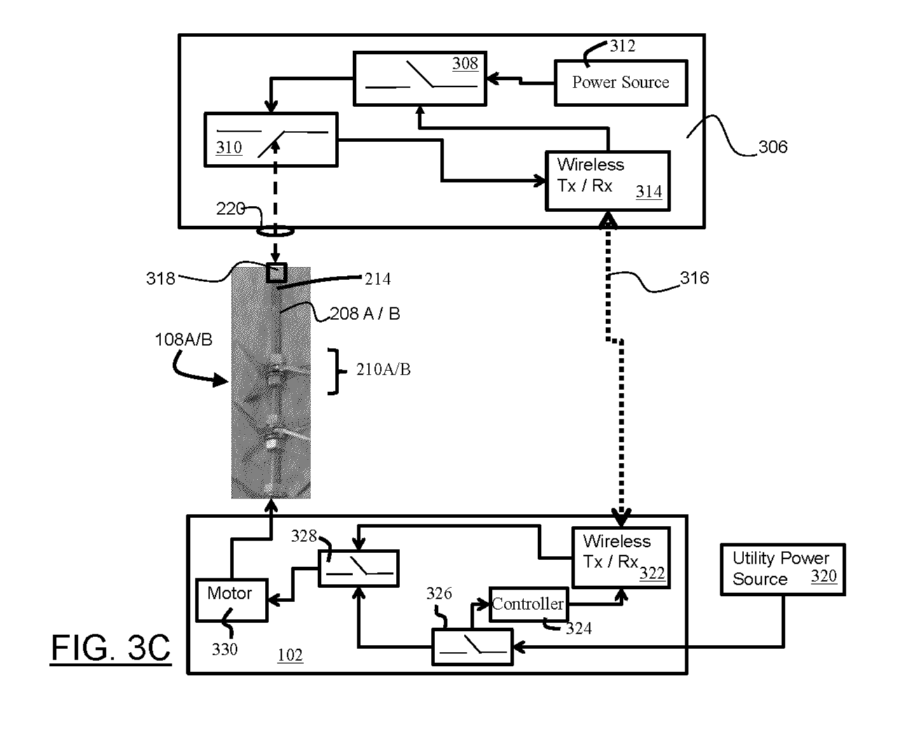

FIG. 1 is an exemplary illustration of a blender and food processor device in accordance with the present invention. As illustrated, the blender and food processor device 100 of the present invention is comprised of a base 102 that houses a motor 330 (FIG. 3C), a vessel 104 in the form of a jug or pitcher with a handle 106 that is detachably mounted on top of the base 102, a blender and processor tool 108 accommodated inside the vessel 104, and a cap 110 that detachably couples with the top opening of the vessel 104. The blender and food processor device 100 further includes an operational control panel 112 on the base 102 for operating the device 100, and a power cord 114 coupled with the base 102 for supply of power to the motor 330.

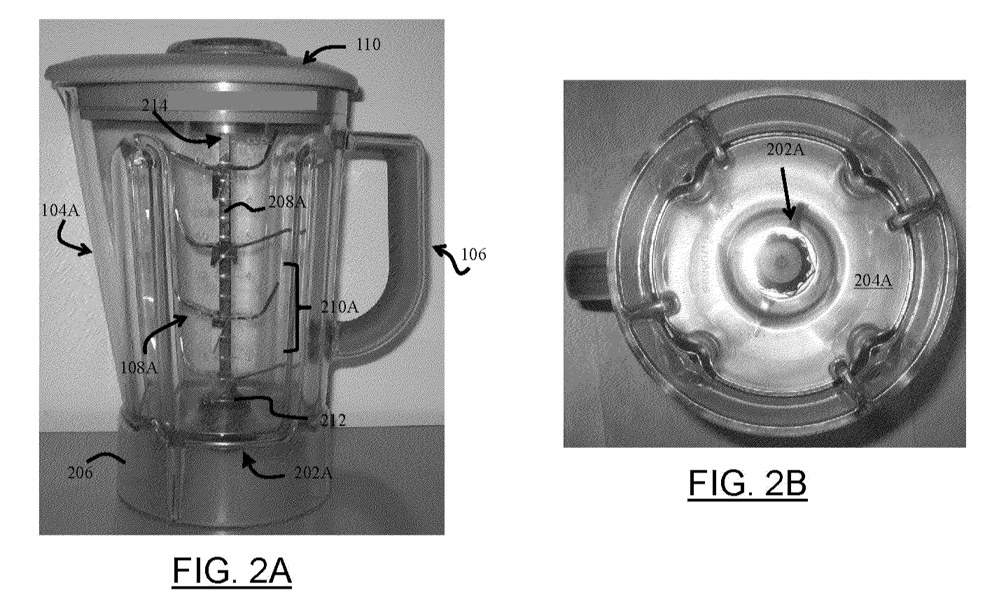

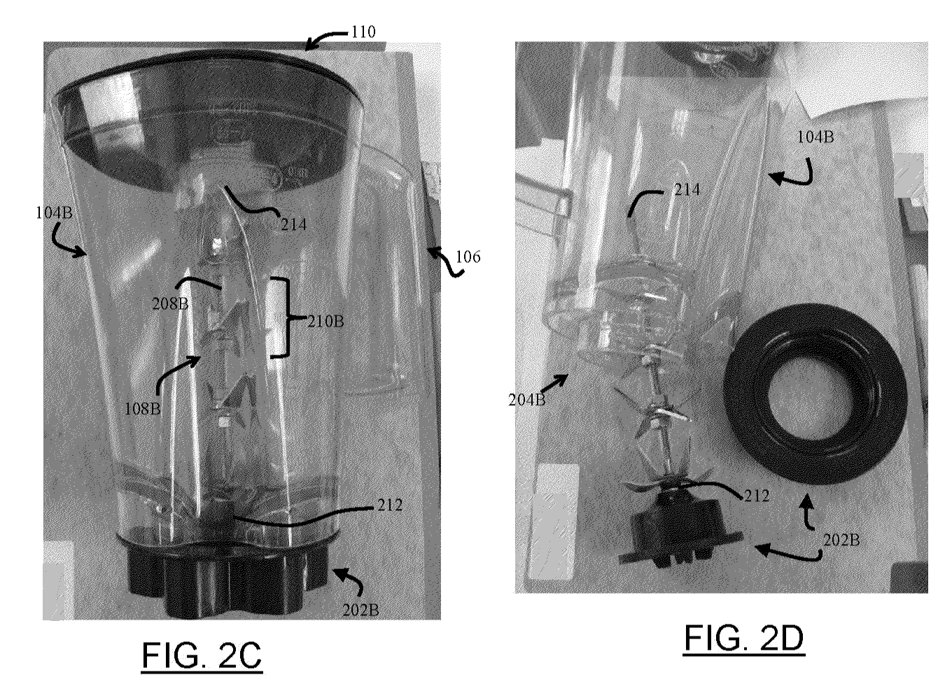

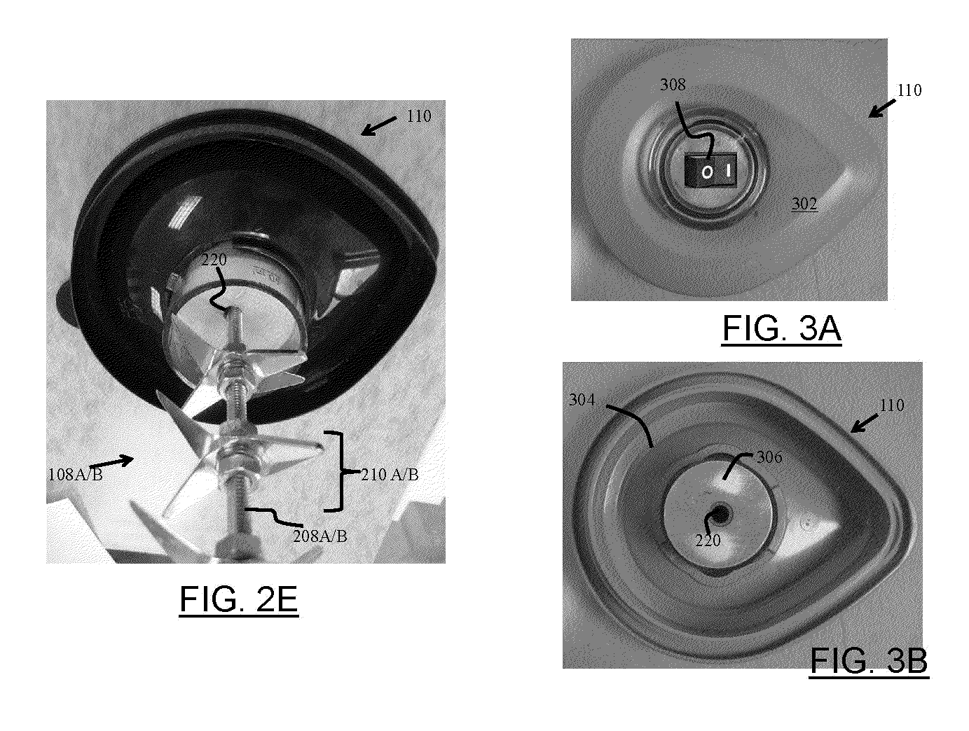

FIGS. 2A to 2D are exemplary illustrations of various vessels in accordance with the present invention. FIGS. 2A and 2B are exemplarily illustrations of a first vessel 104A that accommodates a permanently coupled blender and processor tool 108A and FIGS. 2C and 2D are exemplarily illustrations of a second vessel 104B that accommodate a detachable blender and processor tool 108B. As illustrated in both FIGS. 2A to 2D, the vessels 104A and 104B are generally symmetrical with respect to their central longitudinal axis, and have slightly conical side wall diverging slightly outwardly and upwardly, which gives the vessels 104A and 104B a general circular cross section at most elevations. Both vessels 104A and 104B have an open top at their respective top end that may be closed by the cap 110 and a smooth continuous inner surface. Of course, the vessels 104A and 104B can have different shapes, non-limiting examples of which may include, for instance, square or rectangular with rounded corners between the four walls giving the vessel a square or rectangular cross section in horizontal planes. All of these shapes work well in the vessels of the present invention in that they provide a vessel 104A and 104B having an open top and a smooth continuous inner surface. As further illustrated, both vessels 104A and 104B have a handle 106 that may be designed to be ergonomic to be easily gripped. The handle 106 can be integrally molded with the vessel 104A and 104B or, alternatively, can be a separate piece fixed to the vessel 104A and 104B.

As best illustrated in FIGS. 2A and 2B, the vessel 104A is formed of a generally closed flat bottom 204A that merges in a continuous smooth inner surface with a sidewall that is smooth and continuous from an inner side of the bottom 204A to top of the vessel 104A. Further extending lower from an outer side of the bottom surface 204A is a bottom coupler 206 in a form of periphery wall that enables the vessel 104A to detachably mounts on top of the base 102. As further illustrated, the bottom surface 204A further includes a rotating coupler 202A at its center that couples a rotating shaft 208A of the blender and processing tool 108A with the motor 330 at the base 102. As best illustrated in FIGS. 2C and 2D, the vessel 104B is similar to that of vessel 104A except that it is formed of a generally open bottom 204B that is enclosed by a well-known, conventional rotating coupler 202B that easily disassembles (FIG. 2D) for cleaning. It should be noted that alternatively, the blender and processing tool 108A/B may also be made to be detachably coupled with the rotating coupler 202B at position 212. With this alternative means, the blender and processing tool 108A/B may be removed by lifting the cap and grabbing the top distal end of the tool 108A/B and pulling it out for easy cleaning The detachable coupling of the bender and processing tool 108A/B with the rotating coupler 202B may be accomplished by any well-known male/female coupling mechanism.

Although not illustrated, the motor 330 accommodated within the base 102 includes a conventional rotating drive that is extended out of the base 102 in a well-known manner. As illustrated, the rotating shaft 208A and 208B with a plurality of rotatable blade modules 210A and 210B includes a bottom distal end 212 having the rotating coupler 202A and 202B that couples the rotating shaft 208A and 208B with the bottom 204A and 204B of the vessel 104A and 104B and the rotating drive of the motor 330. It should be noted that the bottom distal end 212 with rotating coupler 202A is permanently coupled with the bottom 204A of the vessel 104A, whereas the bottom distal end 212 with the rotating coupler 202B is detachably coupled with the bottom 204B of the vessel 104B. As best illustrated in FIG. 2E, the rotating shaft 208A and 208B further include a top distal end 214 that is removably inserted within a stabilizing cavity 220 positioned underneath the cap 110. When the motor 330 rotates, the bottom rotatable section of the rotating coupler 202A and 202B rotates to rotate the rotating shaft 208A and 208B, thereby rotating the plurality of rotatable blade modules 210A and 210B to blend and or process food or other materials.

As has been illustrated, the blender and processing tool 108A and 108B may include a rotating shaft 208A with plurality of rotatable blade modules 210A that are at fixed positions along the axial length of the rotating shaft 208A or, alternatively, the rotating shaft 208B may include mechanism that enables the plurality of rotatable blade modules 210B to be adjustably positioned along a longitudinal axis of the rotating shaft 208B. That is, the separation span between a first rotatable blade modules 210B and a next or a subsequently adjacent rotatable blade modules 210B on the rotating shaft 208B may be varied. In general, a rotatable module 210A and 210B may generally include at least two blades. Although illustrated as having a linear longitudinal axis (e.g., as a straight shaft), the rotating shaft 208A and 208B may be one of a straight and non-linear configurations.

As stated above, the cap 110 detachably couples with the top opening of the vessel 108, with the top distal end 214 of the rotating shaft 208A and 208B inserted within the stabilizing cavity 220 that is positioned underneath the cap 110. FIGS. 3A to 3C are exemplary illustrations of the cap, including exemplary schematic illustration of the safety system that enables or disables the activation of the blender and food processor 100 of the present invention. As detailed below, the safety system activates if the top distal end 214 of the rotating shaft 208A and 208B is inserted within the stabilizing cavity 220 and the cap 110 itself is tightly secured onto the top opening of the vessel 104A and 104B. The cap 110 includes a top cap section 302 that includes an ON/OFF safety switch 308, which may comprise of a toggle switch that enables safe activation of the blender and processor device 100, and may automatically or manually toggle to OFF position. In general, the user can manually activate and toggle or turn ON the safety activation mechanism 308 to enable the activation of the blender and processor device 100 (detailed further below). Once the safety activation mechanism 308 is activated (or turned ON), it will remain ON until it is turned OFF either manually or automatically (detailed below). The bottom cap section 304 includes a cap housing 306 that accommodates the cap portion of the safety system. The cap housing 306 also includes the stabilizing cavity 220 that prevents axial wobbling (or lateral vibration) of the rotating shaft 208A and 208B during operation by maintaining a straight alignment of the central longitudinal axis of the shaft from the top distal end 214 to the bottom distal end 212.

As best illustrated in FIG. 3C, the safety system of the present invention is housed in the cap housing 306 and the base 102 of the blender and food processor 100. The safety system includes a power source 312 in a form of a small-disc battery that supplies power to the electronic safety system components housed inside the cap housing 306. Further included is a sealed sensor-switch 310 that activates upon detection of a presence of the top distal end 214 of the rotating shaft 208A/B within the stabilizing cavity 220 underneath the cap 110. The safety switch 308 (also illustrated in FIG. 3A) is coupled in series with the sensor-switch 310 to enable supply of power from the power source 312 to a first wireless transceiver 314 when a user closes the safety switch 308 and the distal end 214 of the rotating shaft 208A/B causes the closure of the sensor-switch 310. The first wireless transceiver 314 is used to transmit a signal 316 when both the sensor-switch 310 and the manual safety switch 308 are closed. This ensures that the cap 110 is fully secured onto the top opening of the vessel 104 prior to operation of the device 100, thereby blocking access to the plurality of the blade modules 210A/B within the vessel 104 for safe operation.

As further illustrated in FIG. 3C, a second wireless transceiver 322 located within the base 102 receives the signal 316 from the first wireless transceiver 314, which signal 316 closes a receiver switch 328. In other words, the receiver switch 328 closes when the cap 110 is fully and securely mounted onto the top opening of the vessel 104, with the distal end 214 of the rotating shaft 208A/B fully inserted inside the stabilizing cavity 220. An operating (e.g., ON/OFF) switch 326 is coupled in series with the receiver-switch 328, and is activated by the user to turn ON/OFF the blender and processor device 100. Therefore, the blender and processor device 100 of the present invention can be turned ON when the safety switch 308, sensor-switch 310, receiver-switch 328, and the operating (e.g., ON/OFF) switching 326 are all closed.

Non-limiting examples of the sensor-switch 310 may include a proximity switch that is activated when a sealed activation mechanism 318 at the top distal end 214 of the rotating shaft 208A/B is inserted inside the stabilizing cavity 220 of the cap 110. Non-limiting example of a proximity switch may be a magnetic proximity switch and the non-limiting example of a sealed activation mechanism 318 at the top distal end 214 of the rotating shaft 208A/B may be a simple magnet. As schematically illustrated in FIG. 3C, an exemplary magnetic proximity switch 310 closes when the exemplary magnet 318 at the top distal end 214 of the rotating shaft 208A/B is inserted within the stabilizing cavity 220 of the cap 110. A non-limiting example of a magnetic proximity switch may be a reed switch. Other non-limiting examples of the combination of sensor-switch 310 and activation mechanism 318 may be an infrared sensor 310 and an infrared proximity switch.

Further included in the safety system is an optional ON/OFF controller/sensor 324 within the base 102 that detects whether the operating (e.g., ON/OFF) switch 326 is opened to shut-OFF the operation of the device 100. If the switches 326 is determined by the controller/sensor 324 to be opened, the controller/sensor 324 transmits a wireless signal 316 via the second wireless transceiver 322 in the base 102 to the first wireless transceiver 314 within the cap housing 306, which, in turn, automatically toggles the safety switch 308 to an open (e.g., OFF) position (if closed), thereby preserving power source 312. Accordingly, the safety switch 308 remains closed when actuated, but may be deactivate and open manually by a user or automatically when the blender and processor device 100 is turned OFF via switch 326 while the cap 110 still remains on top of the vessel 104. A non-limiting, practical application and use of the optional controller/sensor 324 would be when a user activates device 100 to blend or process food, and then turns OFF the device 100 by the switch 326. Thereafter, the user may detach the vessel 104 from the base 102 and store it in a refrigerator but without removing the cap 110 from the top of the vessel 104 or having to remember to turn OFF or open the safety switch 308 on the cap 110. In such an instance the optional controller/sensor 324 will detect that the switch 326 was manually toggled to an OFF position by a user to shut OFF the operation of the device 100, and will transmit the wireless signal 316 via the second wireless transceiver 322 to the first wireless transceiver 314 in the cap housing 306 to automatically turn OFF the safety switch 308, thereby opening the safety circuit in the cap 110 to preserve battery power.

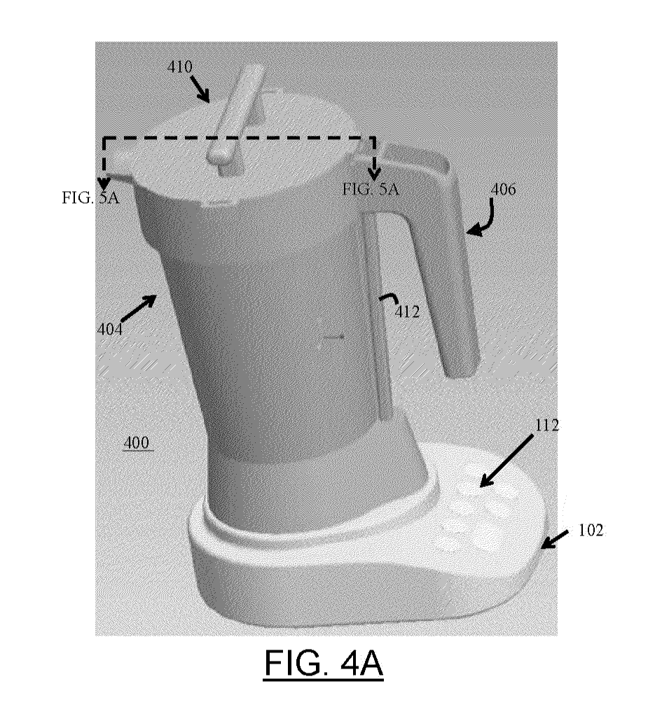

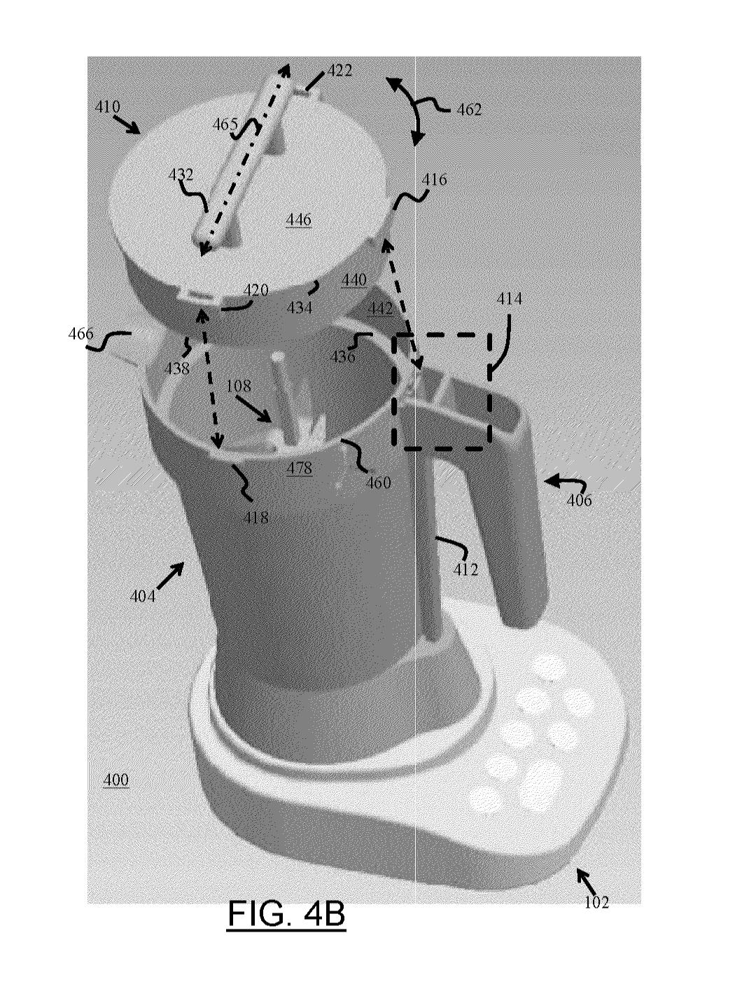

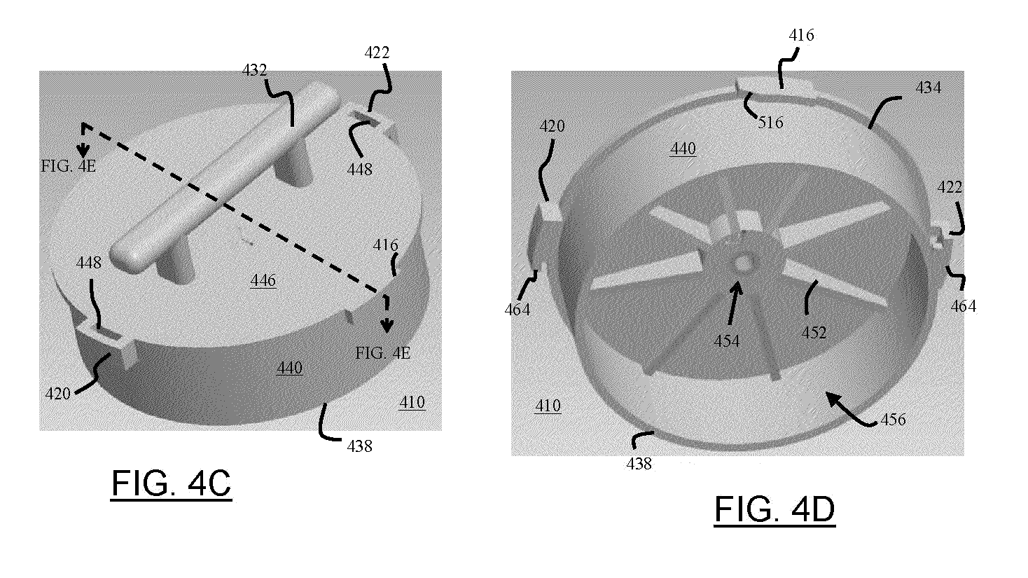

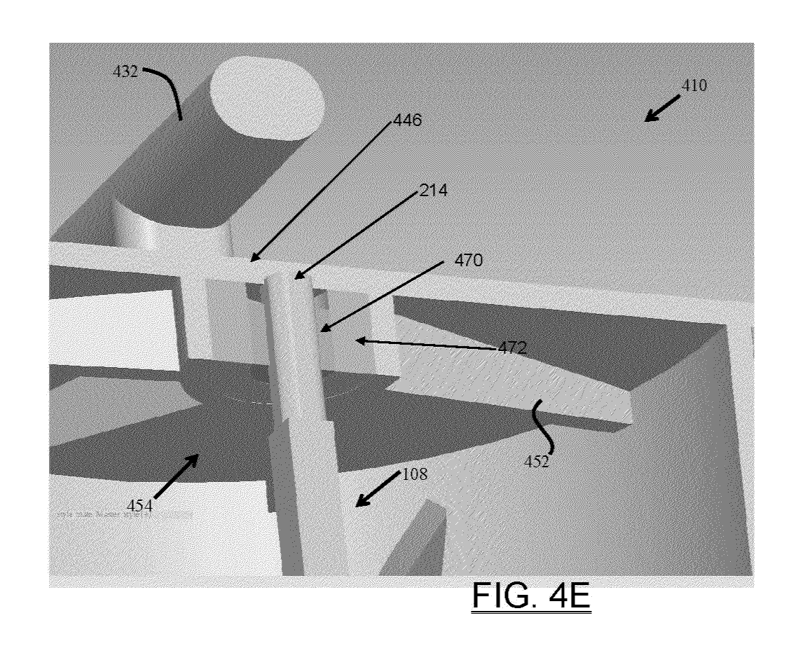

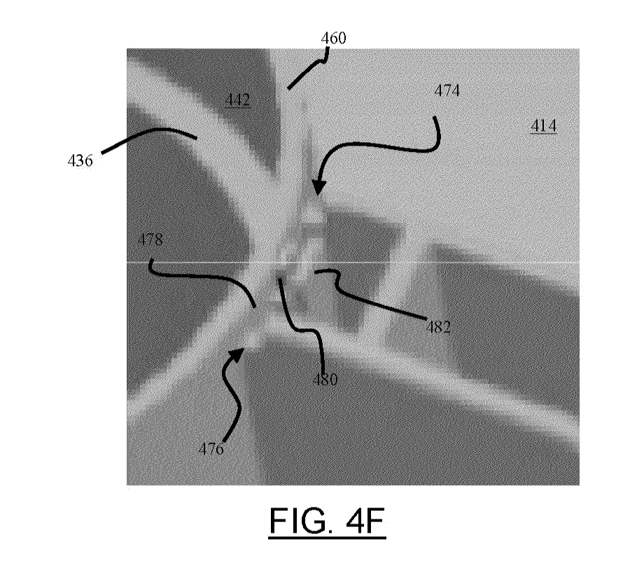

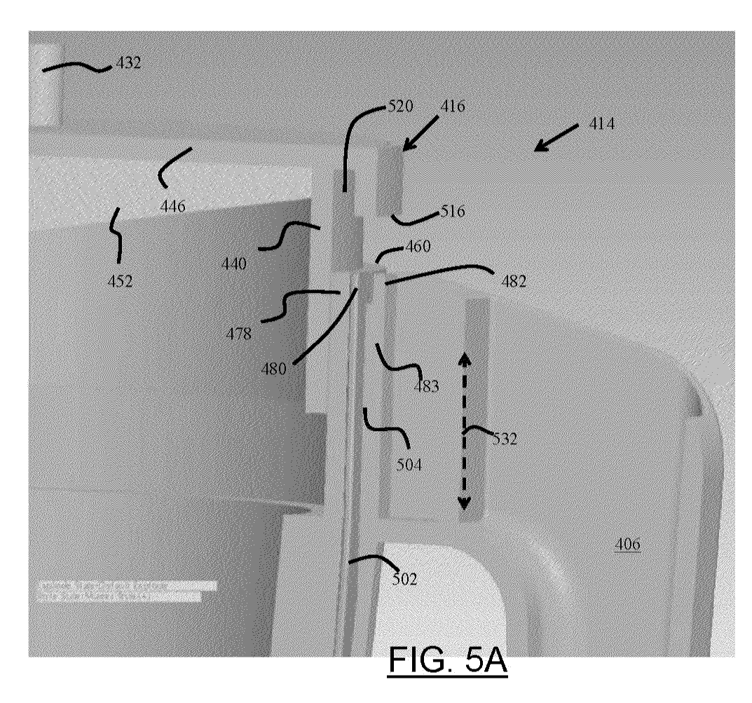

FIGS. 4A to 6 are exemplary illustrations of the various views of a blender and processor 400 that includes another type of safety system in accordance with the present invention. The blender and processor 400 includes similar corresponding or equivalent components, interconnections, and or cooperative relationships as the blender and processor 100 that is shown in FIGS. 1 to 3C, and described above. Therefore, for the sake of brevity, clarity, convenience, and to avoid duplication, the general description of FIGS. 4A to 6 will not repeat every corresponding or equivalent component and or interconnections that has already been described above in relation to blender and processor 100 that is shown in FIGS. 1 to 3C.

FIG. 4A is an exemplary illustration of a blender and processor that uses a different type of safety system in accordance with the present invention. As illustrated, a blender and processor device 400 is comprised a vessel 404 that has handle 406, and includes a top opening and a bottom, with the bottom of the vessel 404 detachably mounted on top of the base 102. The vessel 404 further includes a shaft housing 412 that houses an interlock shaft (detailed below). Further included is a cap 410 that detachably couples with the top opening of the vessel 404 to enable operation thereof.

FIG. 4B is an exemplary illustration of the blender and processor exemplarily illustrated in FIG. 4A, but with a cap detached in accordance with the present invention. FIGS. 4C and 4D are exemplary illustration of the various views of a cap of the blender and processor exemplarily illustrated in FIG. 4A in accordance with the present invention. As illustrated in FIGS. 4A to 4D, the vessel 404 includes an open top that is covered or enclosed by the cap 410. The cap 410 is comprised of a top section 446 with a handle 432, with the top section 446 extending beyond a lateral wall 440 to form a radial lip 434. The lateral wall 440 extends and protrudes from a bottom section 456 of the cap 410. Integral with the lip 434 are a first and a second interlock structures 420 and 422 that are oriented and positioned opposite, diagonally across one another, and an integral safety actuation flange 416 in between the interlock structures 420 and 422. The first and second interlock structures 420 and 422 are comprised of an interlock aperture 448 and an interlock “L” shaped projection 464 that mate with a corresponding set of respective third and fourth interlock structures 418 and 419 (not shown) that are integral with an outer top periphery edge 460 of the vessel 404. The cap 410 further includes the bottom section 456 that provides various ribs 452 for structural integrity of the cap 410 in terms of added strength, and also has a central stabilizing cavity 454 (similar to the stabilizing cavity 220) that receives the top distal end 214 of the rotating shaft 208A/B of the blender and processor tool 108. The stabilizing cavity 220 may comprise of a through-hole whereas the stabilizing cavity 454 is recess or hollow space.

Referring to FIGS. 4A and 4B, it should be noted that the position and orientation of the cap 410 in relation to the vessel 404 in FIGS. 4A and 4B is shown at a closed and locked position/orientation. That is, to close and detachably lock the cap 410 with the vessel 404, a longitudinal axis 465 of the handle 432 is rotated about a reciprocating path 462 to the position shown, enabling the cap 410 to be in the closed and locked position. Accordingly, to actually close and lock the cap 410 onto the vessel 404, the cap 410 must first be oriented to a position where the longitudinal axis 465 is substantially parallel the handle 406 and the spout 466, and lowered so that the lower periphery edge 438 of the lateral wall 440 of the cap 410 is securely seated onto an inner top edge 436 of the vessel 404. This enables the lateral wall 440 of the cap 410 to frictionally contact a top inner lateral wall section 442 of the vessel 404, and the lip 434 of the cap 410 to securely seat onto an outer top periphery edge 460 of the vessel 404. When lowering the cap 410, the stabilizing cavity 454 underneath the cap 410 must also be aligned with the top distal end 214 of the rotating shaft 208A/B of the blender and processor tool 108 so that the distal end 214 may be inserted within the stabilizing cavity 454. The stabilizing cavity 454 (just as the stabilizing cavity 220) prevents axial wobbling (or lateral vibration) of the rotating shaft 208A/B during operation by maintaining a straight alignment of the central axis of the rotating shaft 108 from the top distal end 214 to the bottom distal end 212. As best illustrated in FIG. 4E, the stabilizing cavity 454 and that of 220 are comprised of an inner stationary bushing 470 that receive the top distal end 214 of the blender and processor tool 108 and enable the shaft to rotate securely, and are surrounded by an outer stationary bushing support 472 for supporting the inner stationary bushing 470.

Accordingly, once the cap 410 is secured and seated onto the vessel as described above, the cap 410 is then rotated along path 462 where the first and second interlock structures 420 and 422 on the cap 410 interlock with the respective third and fourth structures 418 and 419 on the vessel 404. That is, as the seated cap 410 is rotated on top of the vessel 410, the third and fourth structures 418 and 419 engage within the “L” shaped projections 464 of the first and second interlock structures 420 and 422 of the cap 410, with structures 418 and 419 top portions extending out of the interlock apertures 448. The cap 410 is rotated along path 462 to the illustrated position (where the longitudinal axis 465 of the handle 432 of the cap 410 is perpendicular to that of the handle 406/spout 466 virtual axis).

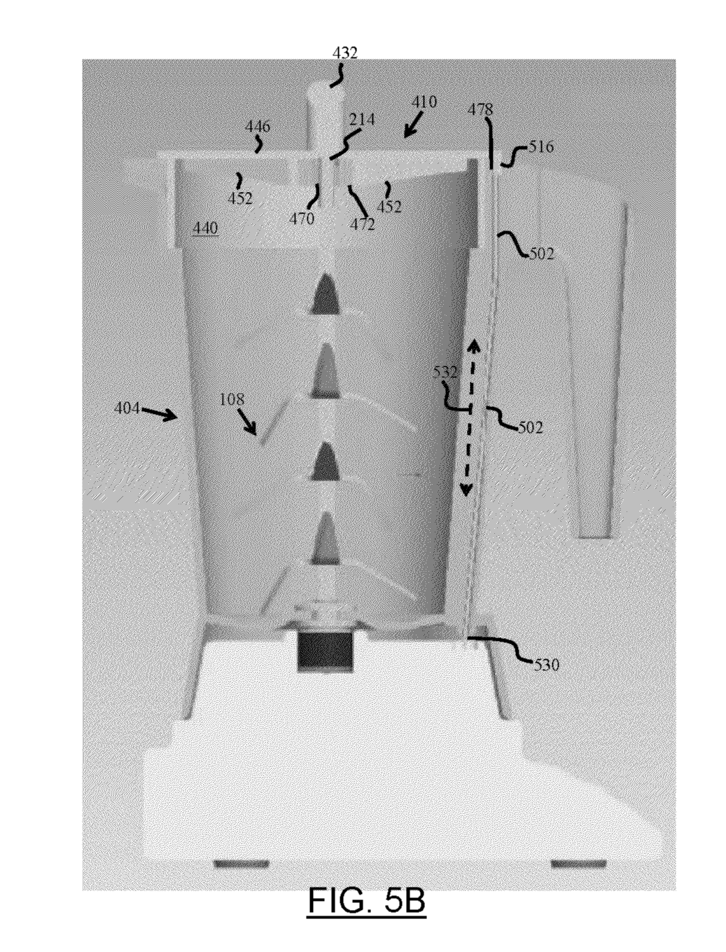

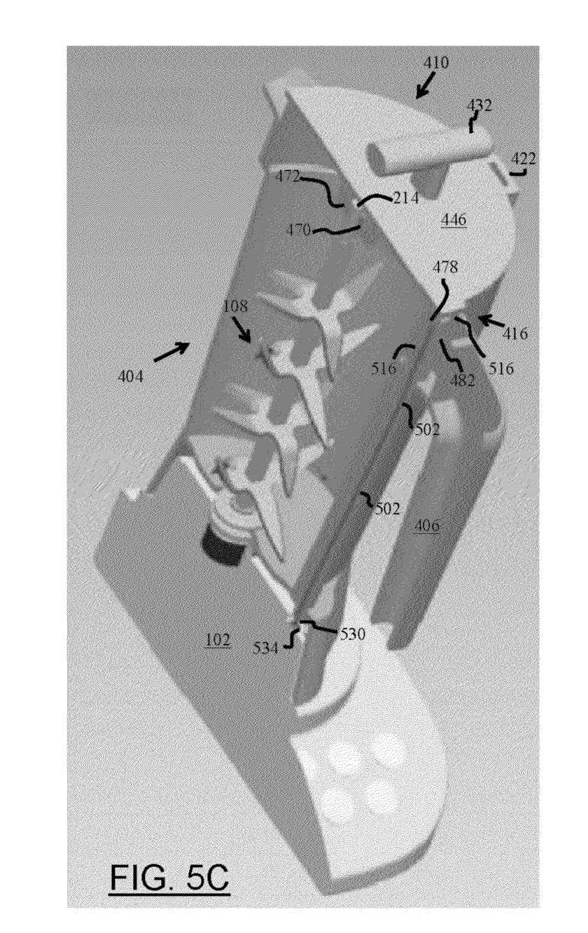

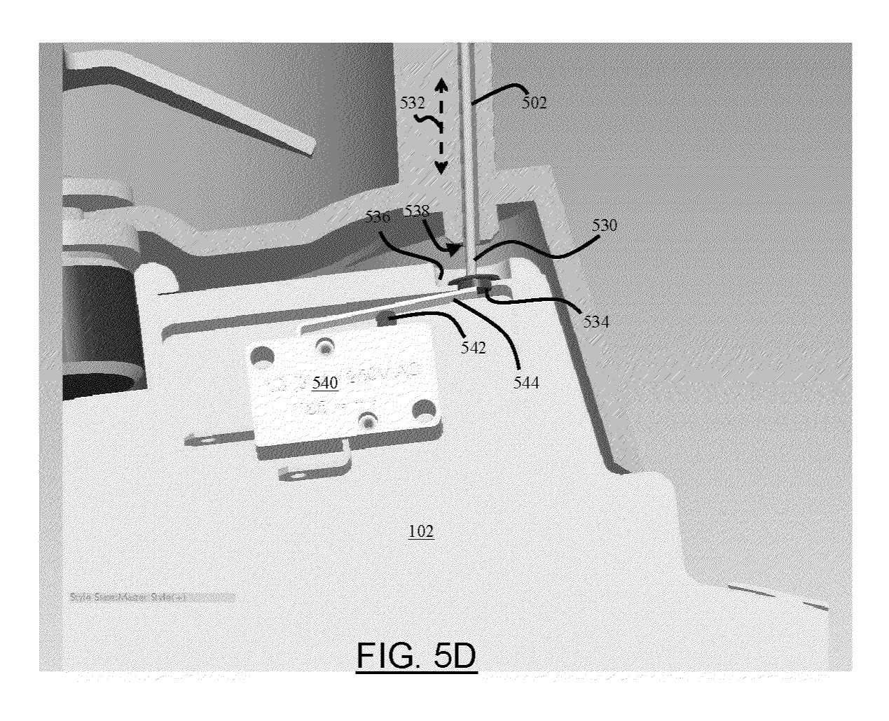

As best illustrated in FIGS. 4F to 5D, rotating the cap 410 along path 462 while in the seated position in relation to the vessel 404 as described above also moves the safety actuation flange 416 integral with the cap 410 to contact and actuate a top distal end 480 of a safety interlock shaft 502 (detailed below), thereby fully interlocking the cap 410 with the vessel 404 and enabling safe operation of the blender and processor device 400. As the cap 410 rotates, the beveled edge 516 of the safety actuation flange 416 slides through the indentations or notches 474 and then 476, over the top distal end 480 of the safety interlock shaft 502, pushing the shaft 502 to a vertically downward direction 532 along longitudinal axis of the shaft 502 within the shaft housing 504. An interlock space 520 of the cap 410 between the lateral wall 440 and the safety actuation flange 416 enables a top periphery section 478 of the vessel 404 to slide within the interlock space 520, while the safety actuation flange 416 is secured and actuates the top distal end 480 of the safety interlock shaft 502 in the downward direction 532. As illustrated, in general, the shaft housing 504 is comprised of the exterior body of the vessel 404 and a support wall 483.

FIGS. 5A to 5D are exemplary sectional views of the blender and processor of FIG. 4A in accordance with the present invention. As illustrated, safety actuation flange 416 actuates and moves the interlock shaft 502 along the reciprocating path 532 when the cap 410 is seated and rotated on top opening of the vessel 404. The movement of the interlock shaft 502 actuates an interlock micro-switch 540 within the base 102, enabling activation of the safety system. That is, the interlock shaft 502 is longitudinally moved along a reciprocating path 532 within the shaft housing 504 by the safety actuation flange 416, which actuates the micro-switch 540. As stated above, the vessel 404 includes the shaft housing 504 that accommodates the interlock shaft 502. The first interlock shaft distal end 480 is substantially flush with a first shaft housing distal end 482, which also accommodates the safety actuation flange 416 upon seating and rotation of the cap 410. A second interlock shaft distal end 530 extends beyond a second shaft housing distal end 538 to contact the interlock micro-switch arm 544 of the interlock micro-switch 540 upon seating and rotation of the cap 410. As further illustrated, the interlock shaft 502 includes an actuator seal 534 at the second interlock shaft distal end 530 that contacts the interlock micro-switch actuator lever or arm 544 to actuate the interlock micro-switch 540 via the micro-switch actuation piston 542. It should be noted that the actuator seal 534 is “hidden” out of reach and is housed within a seal cavity 536, which prevents accidental actuation of the micro-switch, especially when the vessel 404 is detached from the base 102, exposing the actuator seal 534.

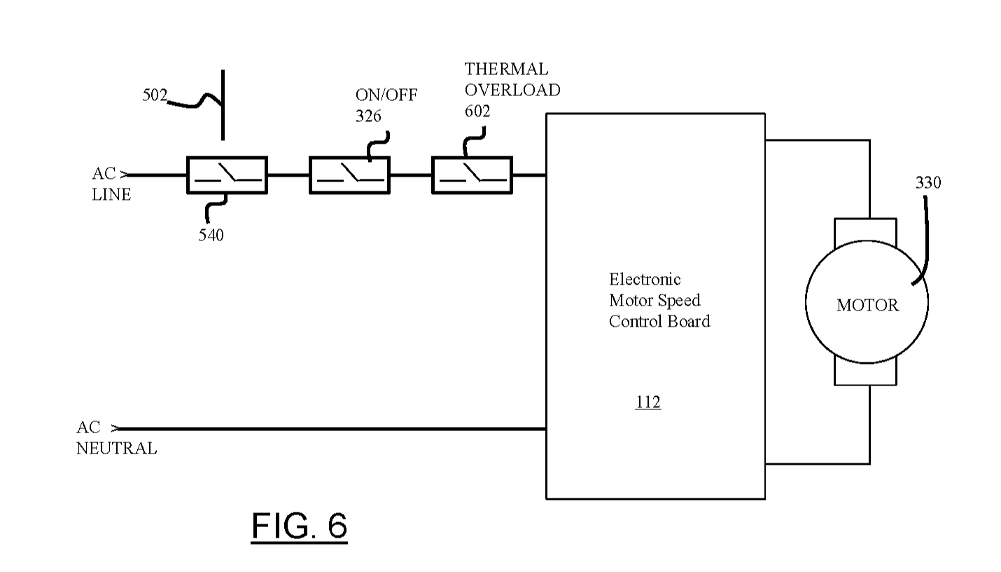

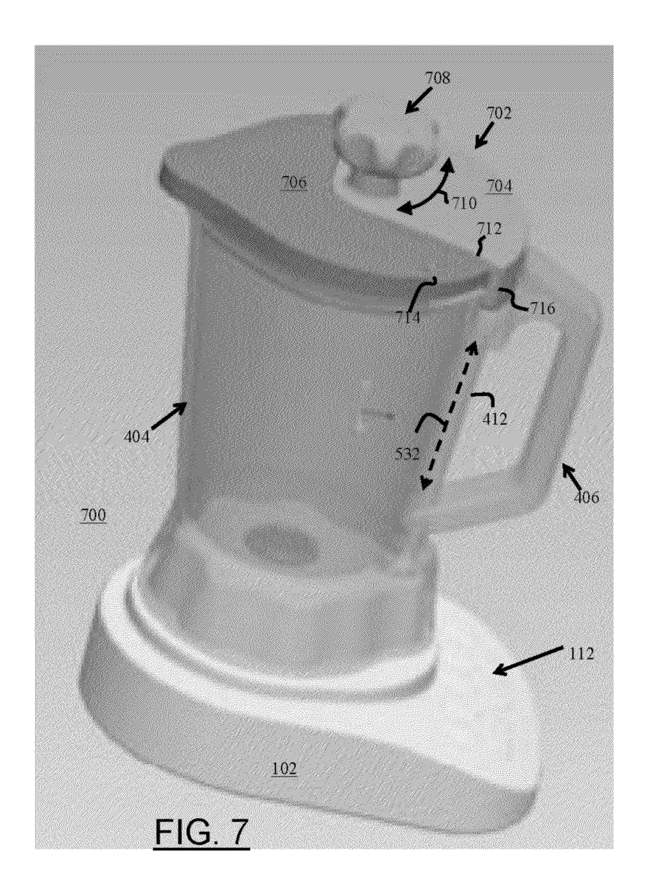

FIG. 6 is an exemplary schematic illustration of the safety system of the present invention for the blender and processor device of FIG. 4A. The safety system is housed in the base 102, and includes the micro-switch 540 that communicates with the outside the base 102 with the interlock shaft 502. The micro-switch 540 is series coupled with an operating ON/OFF switch 326 and a thermal overload switch 602, which, in turn, is coupled with the electronic motor speed control board that enables controlled operation of the motor 330 by a user via the operational control panel 112. When the interlock shaft 502 is longitudinally moved along a reciprocating path 532 within the shaft housing 504 by the safety actuation flange 416, the second interlock shaft distal end 530 actuates the interlock micro-switch actuator lever or arm 544 of the interlock micro-switch 540 to close the switch 540, and upon closure of the ON/OFF switch 326 by a user, the blender and processor device 400 becomes operational. The thermal overload switch 602 is in a normally closed position and opens only when sensing a thermal overload. Accordingly, the blender and processor device 400 will operate if the micro-switch 540 and the operating ON/OFF switch 326 are both closed. This ensures that the cap 410 is fully securely seated and interlocked with the vessel 404 prior to operation of the device 400, thereby blocking access to the plurality of the blade modules 210A/B within the vessel 404 for safe operation.

FIG. 7 is an exemplary illustration of yet another blender and processor 700 that in accordance with the present invention. The blender and processor 700 includes similar corresponding or equivalent components, interconnections, and or cooperative relationships as the blender and processor 100 and 400 that is shown in FIGS. 1 to 6, and described above. Therefore, for the sake of brevity, clarity, convenience, and to avoid duplication, the general description of FIG. 7 will not repeat every corresponding or equivalent component and or interconnections that has already been described above in relation to blender and processor 100 and 400 that is shown in FIGS. 1 to 6.

As illustrated in FIG. 7, the blender and processor 700 is comprised of a cap 702 that is comprised of a first cap piece 706 that is coupled with a second cap piece 704, such that the second cap 704 moves along a reciprocating path 710 in relation to the first cap piece 706, which remains stationary when placed and seated onto the vessel 404 of the blender and processor 700. Once the cap 702 is securely placed and seated onto the vessel 404, the second cap piece 704 is then rotated using the handle 708 along path 710 until the second leading edge 712 of the second cap piece 704 contacts and is blocked from further movement by the first leading edge 714 of the first cap piece 706. At this locked position, the safety actuation flange 716 that is integral with the second cap piece 704 actuates and moves the internally housed interlock shaft 502 to actuate the interlock safety micro-switch 540 housed in the base 102. As with caps 110 and 410, cap 710 also includes a stabilizing cavity, which may be an integral part of one of the stationer first cap piece 706 and the second cap piece 710.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, the safety systems described may be combined and used for all the blender and processor devices disclosed. In other words, the safety system described in relation to the blender and processor 100 may also be used in combination with the safety system illustrated for the blender and processor 400 and 700, or vice versa. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of in the claims herein is not intended to invoke the provisions of 35 U.S.C. 112, Paragraph 6.

What is claimed is:

1. A blender and processor device, comprising:
a base that houses a motor;
a vessel with a handle that includes a top opening and a bottom coupler, with the bottom coupler of the vessel detachably mounted on top of the base;
a cap that detachably couples with the top opening of the vessel;
the motor accommodated within the base includes a rotating drive that is extended out of the base;
a rotating shaft with a plurality of rotatable blade modules includes a bottom distal end having a rotating coupler that couples the rotating shaft with the bottom coupler of the vessel and the rotating drive of the motor;
the rotating shaft further includes a top distal end that is inserted within a stabilizing cavity positioned underneath the cap; and
a safety system that activates to enables activation of the device;
the safety system activates if the top distal end of the rotating shaft is inserted within the stabilizing cavity underneath the cap, and the cap is tightly secured onto the top opening of the vessel.

2. The blender and processor device as set forth in claim 1, wherein:
the rotating shaft is threaded, enabling the plurality of rotatable blade modules to be adjustably mounted on the rotating shaft.

3. The blender and processor device as set forth in claim 1, wherein:
the rotating shaft is one of a straight and non-linear configurations.

4. The blender and processor device as set forth in claim 1, wherein:
a rotatable module of the plurality of rotatable blade modules is comprised of at least two blades.

5. The blender and processor device as set forth in claim 1, wherein:
the safety system includes:
a safety switching system that is comprised of:
a power source;
a sensor-switch that activates upon detection of a presence of the top distal end of the rotating shaft within the stabilizing cavity underneath the cap;
a manual safety switch coupled in series with the sensor-switch that is activated by a user;
a wireless transmitter that transmits a signal when the sensor-switch and the manual safety switch are activated;
a receiver-switch that receives the signal from the wireless transmitter;
an operating switching that is activated by the user and that activates the device only when the receiver-switch is closed.

6. The blender and processor device as set forth in claim 5, wherein:
the power source, the sensor-switch, the manual safety switch, and the wireless transmitter are housed within the cap; and
the receiver-switch and the operating switch are housed within the base.

7. The blender and processor device as set forth in claim 5, wherein:
the power source is a battery.

8. The blender and processor device as set forth in claim 5, wherein:
the sensor-switch is a proximity switch that is activated when an activation mechanism of the top distal end of the rotating shaft is near the proximity switch.

9. The blender and processor device as set forth in claim 8, wherein:
the proximity switch is a magnetic proximity switch and the activation mechanism of the top distal end of the rotating shaft is a magnet; and
the magnetic proximity switch closes when the magnet of the top distal end of the rotating shaft is inserted within the stabilizing cavity of the cap, near the magnetic proximity switch.

10. The blender and processor device as set forth in claim 7, wherein:
the magnetic proximity switch is a reed switch.

11. The blender and processor device as set forth in claim 7, wherein:
the sensor-switch is comprised of:
an infrared sensor; and
an infrared proximity switch.

12. The blender and processor device as set forth in claim 5, wherein:
the receiver-switch is comprised of:
a wireless receiver that receives the wireless transmission signal from the wireless transmitter; and
an auxiliary switch that activates to enable the activation of the device by the operating switch.

13. The blender and processor device as set forth in claim 5, wherein:
the manual safety switch remains closed when actuated, but deactivate and opens automatically.

14. The blender and processor device as set forth in claim 5, wherein:
the operating switch is the ON and OFF switch of the device.

15. The blender and processor device as set forth in claim 1, wherein:
the safety system includes:
an safety actuation flange as an integral part of the cap;
an interlock shaft that is moved by the interlock flange when the cap is detachably coupled with the top opening of the vessel, the movement of which, in turn, actuates an interlock micro-switch within the base, enabling activation of the safety system.

16. The blender and processor device as set forth in claim 15, wherein:
the vessel includes a shaft housing that accommodates the interlock shaft, with a first interlock shaft distal end substantially flush with a first shaft housing distal end, and a second interlock shaft distal end that extends beyond a second shaft housing distal end to contact the interlock micro-switch upon closure of the cap.

17. The blender and processor device as set forth in claim 16, wherein:
the first shaft housing distal end of the vessel accommodates the safety actuation flange upon closure of the cap.

18. The blender and processor device as set forth in claim 16, wherein:
the interlock shaft is longitudinally moved along a reciprocating path within the shaft housing by the safety actuation flange.

19. The blender and processor device as set forth in claim 16, wherein:
the interlock shaft includes an actuator seal at the second interlock shaft distal end that contacts an interlock micro-switch actuator lever to actuate the interlock micro-switch.

20. The blender and processor device as set forth in claim 1, wherein:
the stabilizing cavity is comprised of a stationary bushing support that encloses a stationary bushing within which is inserted the top distal end of the rotating shaft.

21. A blender and processor device, comprising:
a base that houses a motor;
a vessel with a handle that includes a top opening and a bottom coupler, with the bottom coupler of the pitcher detachably mounted on top of the base;
a cap that detachably couples with the top opening of the vessel;
the motor accommodated within the base includes a rotating drive that is extended out of the base;
a rotating shaft with a plurality of rotatable blade modules includes a bottom distal end having a rotating coupler that couples the rotating shaft with the bottom coupler of the vessel and the rotating drive of the motor;
the rotating shaft further includes a top distal end that is inserted within a stabilizing cavity positioned underneath the cap; and
a safety system that activates to enables activation of the device;
the safety system activates if the top distal end of the rotating shaft is inserted within the stabilizing cavity underneath the cap, and the cap is tightly secured onto the top opening of the vessel;
the safety system includes:
a safety switching system that is comprised of:
a power source;
a sensor-switch that activates upon detection of a presence of the top distal end of the rotating shaft within the stabilizing cavity underneath the cap;
a manual safety switch coupled in series with the sensor-switch that is activated by a user;
a wireless transmitter that transmits a signal when the sensor-switch and the manual safety switch are activated;
a receiver-switch that receives the signal from the wireless transmitter;
an operating switching that is activated by the user and that activates the device only when the receiver-switch is closed.

22. A blender and processor device, comprising:
a base that houses a motor;
a vessel with a handle that includes a top opening and a bottom coupler, with the bottom coupler of the vessel detachably mounted on top of the base;
a cap that detachably couples with the top opening of the vessel;
the motor accommodated within the base includes a rotating drive that is extended out of the base;
a rotating shaft with a plurality of rotatable blade modules includes a bottom distal end having a rotating coupler that couples the rotating shaft with the bottom coupler of the vessel and the rotating drive of the motor;
the rotating shaft further includes a top distal end that is inserted within a stabilizing cavity positioned underneath the cap; and
a safety system that activates to enables activation of the device;
the safety system activates if the top distal end of the rotating shaft is inserted within the stabilizing cavity underneath the cap, and the cap is tightly secured onto the top opening of the vessel;
the safety system includes:
an interlock flange as an integral part of the cap;
an interlock shaft that is moved by the interlock flange when the cap is detachably coupled with the top opening of the vessel, the movement of which, in turn, actuates an interlock micro-switch within the base, enabling activation of the safety system.
